(19) United States
(12) Patent Application Publication
(10) Pub. No.: US 2011/0009149 A1
(43) Pub. Date: Jan. 13, 2011

(54) WIRELESS COMMUNICATION METHOD, BASE STATION, INDOOR COMMUNICATION SYSTEM AND HANDOVER METHOD

(75) Inventors: Lin Chen, Shenzhen (CN); Ailin Deng, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD., Shenzhen (CN)

(21) Appl. No.: 12/882,675

(22) Filed: Sep. 15, 2010

Related U.S. Application Data
(63) Continuation of application No. PCT/CN2009/071927, filed on May 22, 2009.

(30) Foreign Application Priority Data
Mar. 27, 2008 (CN) 200810102852.6

(51) Int. Cl. H04B 7/00; H04W 36/00

(52) U.S. Cl. 455/517; 370/331

(57) ABSTRACT

A wireless communication method, a Base Station (BS), an indoor communication system, and a handover method are disclosed. In this method, the working frequency of the service carrier of the indoor coverage system is preset to be different from the working frequency of the service carrier of the outdoor macro cell system, the working frequency of the beacon carrier of the indoor coverage system is preset to be the same as the working frequency of the service carrier of the outdoor macro cell system, and a common channel is allocated on the beacon carrier of the indoor coverage system. With the present invention, the MS can reside in and hand over to the expected wireless communication system smoothly, the intra-frequency interference and pilot pollution between the neighboring wireless communication systems are overcome, and the communication quality of the wireless communication system is improved.

### CROSS-REFERENCE TO RELATED APPLICATIONS

This application is a continuation of International Application No. PCT/CN2009/071927, filed on 22 May 2009, which claims priority to Chinese Patent Application No. 200810102852.6, filed on Mar. 27, 2008, both of which are hereby incorporated by reference in their entireties.

### FIELD OF THE INVENTION

The present invention relates to wireless communication technologies, and in particular, to a wireless communication method, a Base Station (BS), an indoor communication system, and a handover method.

### BACKGROUND OF THE INVENTION

In a mobile communication network, most mobile communication traffic occurs indoors, and the indoor coverage quality of the mobile communication network is essential to the user experience. To improve the experience of the terminal user, the indoor coverage quality needs to be enhanced.

Currently, a Code Division Multiple Address (CDMA) indoor coverage system includes two parts: CDMA signal source and indoor distributed antenna system. The CDMA signal source may be a repeater or a base station (BS), the working frequency of the CDMA signal source may be the same as or different from the frequency of an outdoor macro cell. If the working frequency is the same as the frequency of the outdoor macro cell, intra-frequency soft handover may occur between the CDMA indoor coverage system and the outdoor macro cell.

In the process of implementing the present invention, the inventor finds at least the following problems in the prior art:

(1) As shown in FIG. 1, if an indoor system and an outdoor system share the same frequency, the neighboring window areas of high-rise buildings generally receive intra-frequency signals of multiple outdoor macro cell BSs simultaneously, and the electric wave attenuation from the outdoor macro cell to the window of a high-rise building is small. Therefore, the corresponding signals are stronger, which interferes with the intra-frequency signals of the indoor coverage. Thus, pilot pollution occurs. In an area with the pilot pollution, the Mobile Station (MS) is vulnerable to network disconnection, call drop, low call quality, and low data transmission rate, and therefore the user experience is deteriorated.

(2) If the frequency of the indoor system is different from the frequency of the outdoor system, the neighboring window areas of high-rise buildings can receive signals of multiple outdoor macro cell BSs and indoor system signals of different frequencies simultaneously. As limited by the network selection policies of the MS in the CDMA system, the MS in the CDMA system resides on the basic frequencies of the outdoor macro cell first, and thus the MS in the CDMA system fails to reside in the inter-frequency network of indoor coverage, and the inter-frequency indoor and outdoor networking solution of CDMA is hardly promotable.

The same problems also exist in other similar wireless communication systems.

### SUMMARY OF THE INVENTION

Embodiments of the present invention provide a wireless communication method, a BS, an indoor communication system and a handover method, which can ensure that an indoor MS resides in an inter-frequency network of indoor coverage with priority, and therefore, intra-frequency interference is overcome, and communication quality of the wireless communication system is improved.

A wireless communication method is provided in an embodiment of the present invention. In this method, the working frequency of the service carrier of the indoor coverage system is preset to be different from the working frequency of the service carrier of the outdoor macro cell system, the working frequency of the beacon carrier of the indoor coverage system is preset to be the same as the working frequency of the service carrier of the outdoor macro cell system, and a common channel is allocated on the beacon carrier of the indoor coverage system. The method includes: sending a system message at the working frequency of the beacon carrier of the indoor coverage system through the common channel, where the system message carries only information about the working frequency of the service carrier of the indoor coverage system, and the system message is used to instruct the MS to migrate to the working frequency of the service carrier of the indoor coverage system.

A BS includes:

a service carrier unit, configured to preset the working frequency of the service carrier of the indoor coverage system to be different from the working frequency of the service carrier of the outdoor macro cell system; and

a beacon carrier unit, configured to preset the working frequency of the beacon carrier to be the same as the working frequency of the service carrier of the outdoor macro cell system, allocate a common channel on the beacon carrier of the indoor coverage system, and send a system message at the working frequency of the beacon carrier of the indoor coverage system through the common channel, where the system message carries only information about the working frequency of the service carrier of the indoor coverage system, and the system message is used to instruct a Mobile Station (MS) to migrate to the working frequency of the service carrier of the indoor coverage system.

An indoor communication system includes:

a BS, configured to: preset the working frequency of the service carrier of the indoor coverage system to be different from the working frequency of the service carrier of the outdoor macro cell system, preset the working frequency of the beacon carrier of the indoor coverage system to be the same as the working frequency of the service carrier of the outdoor macro cell system, allocate a common channel on the beacon carrier of the indoor coverage system, and send a system message at the working frequency of the beacon carrier of the indoor coverage system through the common channel, where the system message carries only information about the working frequency of the service carrier of the indoor coverage system, and the system message is used to instruct the MS to migrate to the working frequency of the service carrier of the indoor coverage system; and

an indoor distributed antenna, configured to receive and send information for the BS.

A method for handover between wireless communication systems includes:

by an MS, receiving a system message sent by an indoor coverage system at the working frequency of the beacon carrier of the indoor coverage system when the MS moves from an outdoor macro cell system to the indoor coverage system, where the system message carries only information about the working frequency of the service carrier of the indoor coverage system, the working frequency of the service carrier of the indoor coverage system is different from the working frequency of the service carrier of the outdoor macro cell system, and the working frequency of the beacon carrier of the indoor coverage system is the same as the working frequency of the service carrier of the outdoor macro cell system; and

handing over to the working frequency of the service carrier of the indoor coverage system according to the information about the working frequency of the service carrier of the indoor coverage system in the system message.

A method for handover between wireless communication systems includes:

by an MS, obtaining preset inter-frequency neighboring cell information when moving from an indoor coverage system to an outdoor macro cell system, where the inter-frequency neighboring cell information indicates that the cell on the working frequency of the service carrier of the indoor coverage system is an inter-frequency neighboring cell of the cell on the working frequency of the service carrier of the outdoor macro cell system; and

handing over from the working frequency of the service carrier of the indoor coverage system to the working frequency of the service carrier of the outdoor macro cell system according to the inter-frequency neighboring cell information.

In the technical solution under the present invention, a BS that includes the beacon carrier provides the signal source, so as to enable a hybrid inter-frequency networking mode to be applied between neighboring wireless communication systems, and therefore the MS can reside in and hand over to the indoor coverage system smoothly. In this way, the intra-frequency interference and pilot pollution between the indoor coverage system and the outdoor macro cell system are overcome, and therefore the communication quality of the wireless communication system is improved.

### BRIEF DESCRIPTION OF THE DRAWINGS

FIG. 1 shows a scenario of pilot pollution in the prior art;

FIG. 2 shows a structure of a wireless communication system provided in an embodiment of the present invention;

FIG. 3 shows a structure of an indoor coverage system of a BS that includes two ordinary beacon carriers in an embodiment of the present invention;

FIG. 4 shows a structure of an indoor coverage system of a BS that includes one hopping beacon carrier in an embodiment of the present invention;

FIG. 5 shows a frequency hopping process provided in an embodiment of the present invention; and

FIG. 6 shows a structure of a BS provided in an embodiment of the present invention.

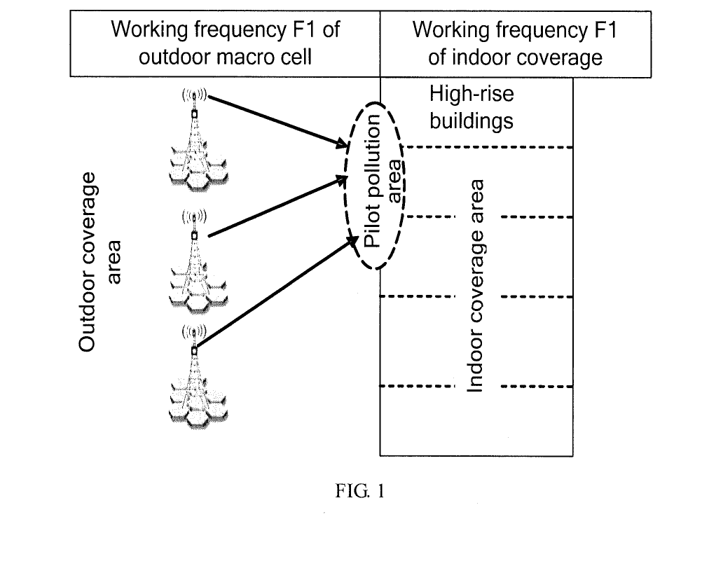

### DETAILED DESCRIPTION OF THE EMBODIMENTS

In the wireless communication solution disclosed herein, a common channel and a service channel are allocated on the service carrier of the indoor coverage system, and the working frequency of the service carrier is different from the working frequency of the service carrier of the outdoor macro cell system to implement inter-frequency networking. A common channel is allocated on the beacon carrier of the indoor coverage system, and a system message is sent through the common channel, where the system message carries only information about the working frequency of the service carrier of the indoor coverage system. The working frequency of the beacon carrier is the same as the working frequency of the service carrier of the outdoor macro cell system. In this way, through the intra-frequency instruction, the MS can hand over to or reside in the indoor coverage system smoothly, namely, the MS can access the working frequency of the service carrier of the indoor coverage system conveniently according to the information in the system message.

In an embodiment of the present invention, the working frequency of the beacon carrier of the indoor coverage system may be set to be the same as the working frequency of the service carrier of the outdoor macro cell system fixedly. Alternatively, the working frequency of the beacon carrier may be set to be the working frequency of the service carrier of the outdoor macro cell system through round robin. That is, by way of frequency hopping, the working frequency of each service carrier of the outdoor macro cell system is used as the working frequency of the beacon carrier of the indoor coverage system. For example, the service carrier changes periodically within the frequency range of the outdoor macro cell system to replace multiple independent beacon carriers.

If frequency hopping is applied, the preset hopping configuration information needs to be obtained in the foregoing processing procedure to determine the working frequency of the beacon carrier. The hopping configuration information may include the working frequencies covered in the hopping range (namely, a working frequency of each service bearer of the outdoor macro cell system) and the hopping mode between the working frequencies (for example, the hopping period or hopping interval).

For ease of handover, in this embodiment, the cell on the working frequency of the service carrier of the indoor coverage system may be set as an inter-frequency neighboring cell of the cell on the working frequency of the service carrier of the outdoor macro cell system; and the cell on the working frequency of the beacon carrier of the indoor coverage system may be set as an intra-frequency neighboring cell of the cell on the working frequency of the service carrier of the outdoor macro cell system. For example, the corresponding intra-frequency neighboring cell and inter-frequency neighboring cell are set in a Base Station Controller (BSC).

In an embodiment of the present invention, the indoor coverage system and the outdoor macro cell system may belong to the same operator or different operators, and may be the communication networks of the same mode or different modes.

A method for handover between the wireless communication systems is provided in an embodiment of the present invention. The method may include the following steps:

The MS moves from an outdoor macro cell system to an indoor coverage system, where the working frequency of the service carrier differs between the indoor coverage system and the outdoor macro cell system, and the two systems constitute inter-frequency neighboring cells.

The MS receives a system message sent by the indoor coverage system through the working frequency of the beacon carrier, where the system message carries only information about the working frequency of the service carrier of the indoor coverage system, and the working frequency of the beacon carrier is the same as the working frequency of the service carrier of the outdoor macro cell system, and the two systems constitute intra-frequency neighboring cells.

The MS can hand over to the working frequency of the service carrier of the indoor coverage system smoothly according to the information about the working frequency of the service carrier of the indoor coverage system in the system message. That is, as instructed by the system message sent through the beacon carrier, the MS can hand over from the outdoor macro cell system to the indoor coverage system smoothly.

The technical solution described above is applicable to any wireless communication network that includes an indoor coverage system and an outdoor macro cell system, namely, applicable to various application scenarios of broad-sense indoor coverage systems and outdoor macro cell systems with serious pilot pollution, for example, wireless communication networks that involve elevated bridges and roads, or wireless communication networks that involve vast water surfaces or sea surfaces, or vast uplands. The technical solution under the present invention overcomes the pilot pollution, and improves communication quality in different coverage areas.

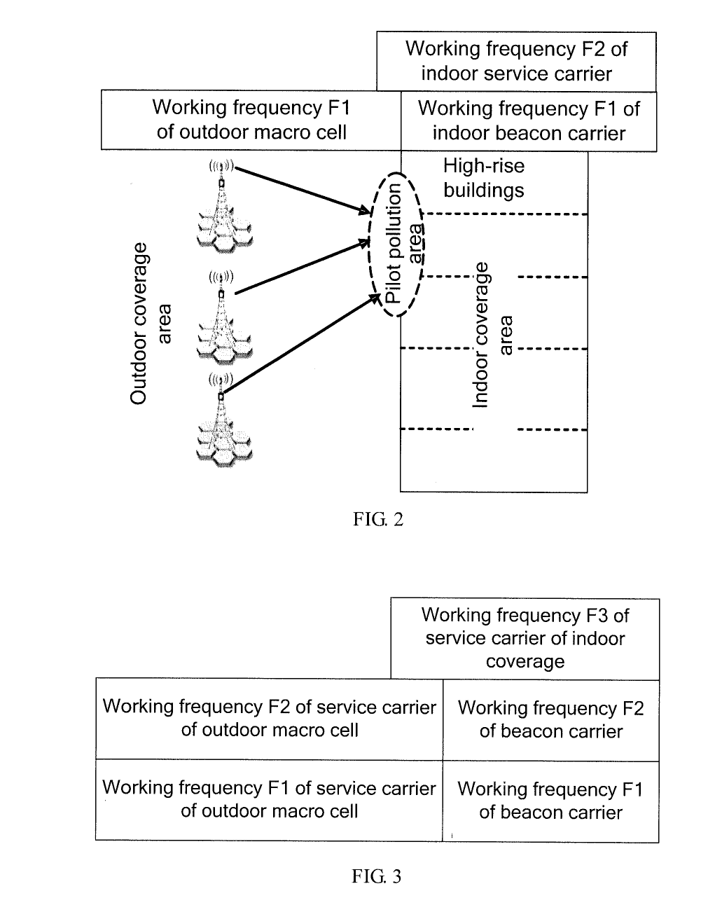

It is assumed that the technical solution is applied to a CDMA wireless communication network that includes an indoor coverage system and an outdoor macro cell system. As shown in FIG. 2, the corresponding indoor solution includes a Base Station Subsystem (BSS), namely, an indoor coverage BS, that includes a beacon carrier, and an indoor distributed antenna system. The working frequency of the service carrier of the indoor coverage BS is set to be different from the working frequency of the service carrier of the outdoor macro cell system to avoid intra-frequency interference or pilot pollution between the indoor coverage system and the outdoor macro cell system. The service carrier of the indoor coverage BS includes a CDMA common channel and a service channel to absorb indoor traffic and provide access services for the MSs in the indoor coverage area. One or more beacon carriers of the BS have at least the corresponding CDMA forward common channel, and the working frequency of the beacon carrier is the same as the working frequency of the outdoor macro cell system. The beacon carrier is configured to enable the CDMA MS in the indoor area to reliably reside in the indoor inter-frequency network (namely, the indoor coverage system); and instruct the MS to hand over from the outdoor macro cell system to the indoor coverage system, namely, the BS that includes the beacon carrier instructs the MS in the indoor coverage area to hand over to a different working frequency of the indoor coverage area smoothly to avoid intra-frequency interference of the outdoor coverage area.

The embodiments of the present invention are applicable to CDMA 1X systems, CDMA 1X EV-DO systems, and other mobile communication systems of a similar scenario.

To make the present invention clearer, the following provides details about the implementation process of the embodiments of the present invention with reference to the accompanying drawings.

### Embodiment 1

As shown in FIG. 3, an outdoor macro cell system (namely, a neighboring wireless communication system) has two working frequencies: F1 and F2; a CDMA indoor coverage system includes a BSS inclusive of two beacon carriers and an indoor distributed antenna system. The working frequency of the service carrier of the BSS in the CDMA indoor coverage system is F3, and the working frequencies of the two beacon carriers are F1 and F2. The two beacon carriers have a forward CDMA common channel, and keep transmitting the corresponding forward common information messages continuously. Meanwhile, the working frequency (F1) of the beacon carrier, the working frequency (F2) of the beacon carrier, and the working frequency (F3) of the service carrier of the indoor coverage system deliver a system message to the MS through their respective common channels, and the channel list field in all the system messages includes only F3. In this way, the CDMA MS in the indoor area can reside onto F3 of the indoor inter-frequency network according to the frequency information in the channel list field of the system message.

In Embodiment 1, the call processing procedure of the MS in the indoor coverage system includes:

When the MS in the indoor coverage system is powered on, the MS captures the basic frequency F1 of the beacon carrier first, and receives a system message from the forward common channel of F1; because the channel list field in the system message includes only the working frequency F3 of the service carrier of the indoor coverage system, the MS migrates from F1 to the working frequency F3 of the service carrier of the indoor coverage system automatically according to the information in the system message and the Hash algorithm in the CDMA mobile communication standard; and calls will be initiated or paging will be received on F3 of the indoor coverage system in the subsequent communication process.

In Embodiment 1, the corresponding system messages include but are not limited to the synchronization channel message, channel list message, system parameter message, and neighboring cell list message.

In the subsequent call processing procedure, because F3 of the indoor coverage system is different from F1 and F2 of the outdoor macro cell system, the intra-frequency interference caused by intra-frequency networking is prevented, and the indoor communication quality is improved significantly.

In Embodiment 1, the procedure of MS handover between the indoor coverage system and the outdoor macro cell system includes:

(1) MS Handover from Indoor to Outdoor

The handover procedure of an idle MS includes:

The cells of F1 and F2 of the outdoor macro cell system are preset as inter-frequency neighboring cells of F3 of the indoor BS. In this way, the MS can hand over to F1 and F2 of the outdoor macro cell system according to the preset inter-frequency neighboring cell information of the indoor BS in the process of handover from indoor to outdoor, and the MS in the idle state hands over from indoor to outdoor smoothly.

The handover procedure of an MS in the service state includes:

The cells of F1 and F2 of the outdoor macro cell system are preset as inter-frequency neighboring cells of F3 of the indoor BS; afterward, through Mobile Assisted Hard Hand Over (MAHHO), the MS in the service state hands over from the indoor coverage system to the outdoor macro cell system smoothly.

(2) MS Handover from Outdoor to Indoor

The handover procedure of an idle MS includes:

The cells corresponding to the working frequency F1 of the beacon carrier of the indoor coverage system are preset as intra-frequency neighboring cells of the working frequency F1 of the outdoor macro cell system, and the cells corresponding to the working frequency F2 of the indoor beacon carriers are preset as intra-frequency neighboring cells of the working frequency F2 of the outdoor macro cell system. In this way, when the MS resides on F1 of the outdoor macro cell system first and then moves to the indoor coverage system, the MS in the idle state will hand over to F1 of the beacon carrier first, and receive a system message on the working frequency F1 of the beacon carrier of the indoor coverage system, where the system message is sent through the working frequency F1 of the beacon carrier and carries only the channel list of F3. Afterward, the MS migrates to F3 of the indoor coverage system automatically through a Hash algorithm according to the information in the system message. If the MS resides on F2 of the outdoor macro cell system first, the MS in the idle state hands over to F2 of the beacon carrier first, and receives a system message on the working frequency F2 of the beacon carrier of the indoor coverage system, where the system message is sent through the working frequency F2 of the beacon carrier and carries only the channel list of F3; and then migrates to F3 of the indoor coverage system automatically according to the Hash algorithm.

The handover procedure of an MS in the service state includes:

The cells corresponding to the working frequency F1 of the beacon carrier of the indoor coverage system are preset as intra-frequency neighboring cells of the working frequency F1 of the outdoor macro cell system, and the cells corresponding to the working frequency F2 of the beacon carriers of the indoor coverage system are preset as intra-frequency neighboring cells of the working frequency F2 of the outdoor macro cell system. In this way, when the working frequency F1 of the outdoor macro cell system is in the communication state (namely, the service state) and the MS moves to the indoor area, the MS hands over to F3 carrier (namely, F3) of the indoor coverage system as instructed by F1 of the beacon carrier. After the MS hands over to the working frequency F3 of the indoor coverage system, no interference is generated by the working frequency F1 or F2 of the outdoor macro cell system, and high communication quality is ensured.

### Embodiment 2

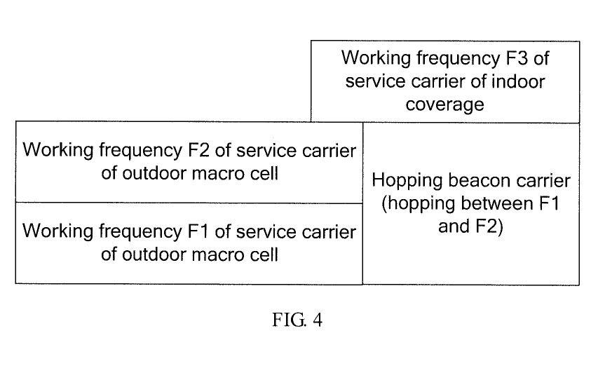

As shown in FIG. 4, an outdoor macro cell system has two working frequencies: F1 and F2. A CDMA indoor coverage system includes a BSS inclusive of a hopping beacon carrier and an indoor distributed antenna system. The working frequency of the service carrier of the indoor coverage BS is F3. The working frequency of the hopping beacon carrier hops between F1 and F2 at preset periods. Within one hopping period, each beacon carrier should transmit at least one complete forward CDMA common channel message to the MS through the working frequencies F1 and F2. In this way, the MS can use the complete forward CDMA common channel message to access the indoor coverage system. In this way, the sent message includes only the working frequency F3 of the indoor coverage BS, and therefore, the CDMA MS in the indoor area can reside on the working frequency F3 of the indoor inter-frequency network, namely, access the communication network through the CDMA indoor coverage system.

The complete forward CDMA common channel message may be a synchronization channel message, a channel list message, a system parameter message, or a neighboring cell list message, and so on.

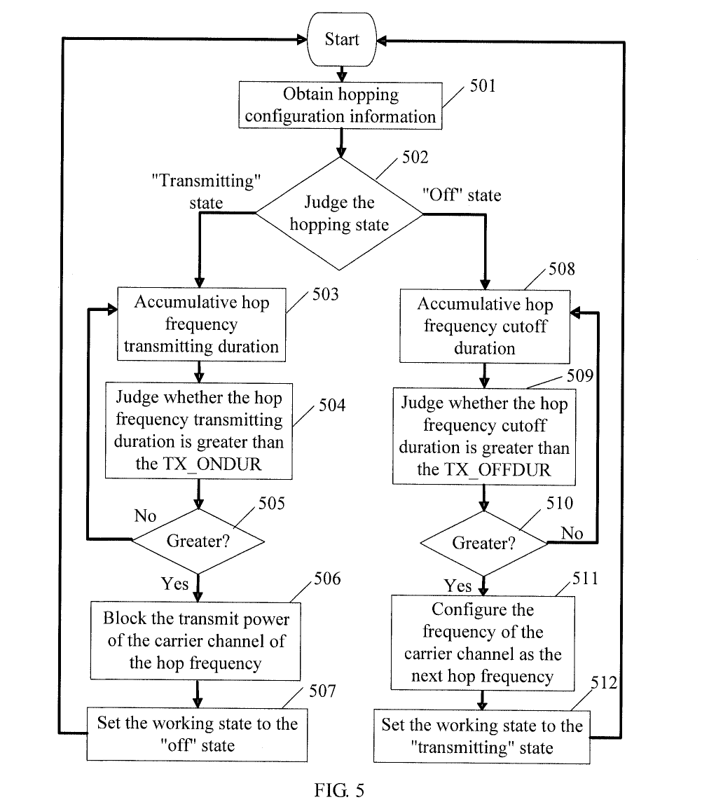

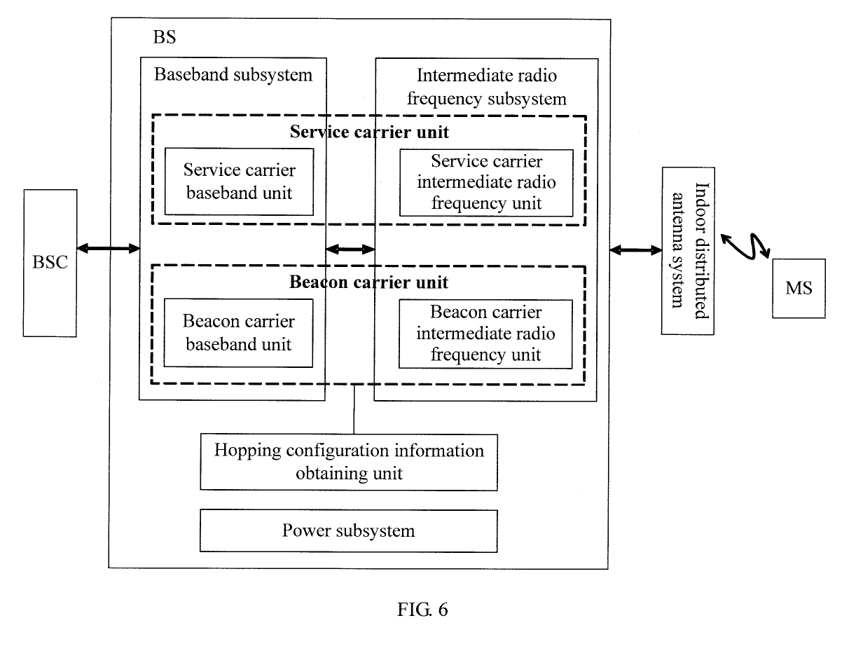

Further, as shown in FIG. 5, the frequency hopping process may include the following steps:

Step 501: Obtain the hopping configuration information. The hopping configuration information includes the working frequency covered in the hopping range, and mode of hopping between the working frequencies, for example, hop frequency transmitting duration “TX_ONDUR”, or hop frequency cutoff duration “TX_OFFDUR”.

Step 502: Judge whether the current hopping state is the “transmitting” state or the “off” state. If the current hopping state is the “transmitting” state, execute steps 503-507; if the current hopping state is the “off” state, execute steps 508-512.

Step 503: Measure the accumulative hop frequency transmitting duration.

Step 504 and step 505: Judge whether the accumulative hop frequency transmitting duration is greater than the hop frequency transmitting duration “TX_ONDUR”; if so, execute step 506; if not, execute step 503.

Step 506 and step 507: Block the transmit power of the channel (namely, the carrier channel) of the working channel corresponding to the current hop frequency, and set the working state to “off”. Repeat step 501.

Step 508: Measure the accumulative hop frequency cutoff duration.

Step 509 and step 510: Judge whether the accumulative hop frequency cutoff duration is greater than the hop frequency cutoff duration “TX_OFFDUR”; if so, execute step 511; if not, execute step 508.

Step 511 and step 512: Configure the working frequency (namely, the frequency of the carrier channel) of the current hop frequency to be the next hop frequency in the working frequencies covered in the hopping range, and set the working state to “transmitting”. Repeat step 501.

In this solution, the BS inclusive of the hopping beacon carrier serves as the signal source of the indoor coverage system in place of the BS inclusive of multiple ordinary beacon carriers, thus reducing the number of carriers required by the BS, and saving the cost of the BS. In the case of expansion of the outdoor macro cell system, for example, expansion from 2 carriers to 3 carriers, it is necessary to configure only data (for example, modify the frequency range of the hopping process through the corresponding interface) for the indoor coverage system, but not necessary to modify hardware.

Moreover, the multi-carrier feature of the BS is fully used in this embodiment to reduce the application cost.

An indoor communication system and a BS are provided in an embodiment of the present invention. As shown in FIG. 6, the indoor communication system may include:

a BS, configured to: allocate a common channel and a service channel on the service carrier of the indoor coverage system, where the working frequency of the service carrier is different from the working frequency of the service carrier of the outdoor macro cell system; and allocate the common channel on the beacon carrier of the indoor coverage system, and send a system message through the common channel, where the system message carries only information about the working frequency of the service carrier of the indoor coverage system, and the working frequency of the beacon carrier is the same as the working frequency of the service carrier of the outdoor macro cell system; and

an indoor distributed antenna, configured to receive and send information for the BS to facilitate information interactions between the BS and the MS.

The following provides more details about the structure of the BS. As shown in FIG. 6, the BS may include a service carrier unit and a beacon carrier unit.

The service carrier unit is configured to allocate a common channel and a service channel on the service carrier of the indoor coverage system, where the working frequency of the service carrier is different from the working frequency of the service carrier of the outdoor macro cell system. Because the BS may include a baseband subsystem and an intermediate radio frequency subsystem, the service carrier unit may be subdivided into a service carrier baseband unit for processing the baseband part and a service carrier intermediate radio frequency unit for processing the intermediate radio frequency part.

The beacon carrier unit is configured to allocate a common channel on the beacon carrier of the indoor coverage system, and send a system message through the common channel, where the system message carries only information about the working frequency of the service carrier of the indoor coverage system, and the working frequency of the beacon carrier is the same as the working frequency of the service carrier of the outdoor macro cell system. The working frequency of the beacon carrier of the beacon carrier unit may be set to be the same as the working frequency of each service carrier of the outdoor macro cell system fixedly, or, the working frequency of the beacon carrier may be set to be the working frequency of each service carrier of the outdoor macro cell system through round robin, namely, the working frequency of the corresponding beacon carrier is determined through frequency hopping. Because the BS may include a baseband subsystem and an intermediate radio frequency subsystem, the beacon carrier unit may be subdivided into a beacon carrier baseband unit for processing the baseband part and a beacon carrier intermediate radio frequency unit for processing the intermediate radio frequency part.

If frequency hopping is applied to determine the working frequency of the beacon carrier, the BS may further include a hopping configuration information obtaining unit, which is configured to obtain hopping configuration information and determine the working frequency of the beacon carrier applied by the beacon carrier unit according to the hopping configuration information. The hopping configuration information includes the working frequencies covered in the hopping range and the hopping mode between the working frequencies (for example, hopping period or hopping interval).

The BS shown in FIG. 6 may further include a power subsystem, which supplies power to the BS.

In conclusion, through the technical solutions disclosed in all the embodiments above, a wireless communication device such as a BS inclusive of a beacon carrier in a wireless communication system (such as a CDMA indoor coverage system) provides the signal source, an inter-frequency networking mode is applied between the indoor coverage system and the outdoor macro cell system, and the MS can reside in and hand over to the corresponding wireless communication system smoothly. The intra-frequency interference and pilot pollution between the indoor coverage system and the outdoor macro cell system are overcome, and the communication quality of the wireless communication system is improved.

By using the BS inclusive of a beacon carrier to instruct the MS and using different frequencies to bear services, the embodiments of the present invention enable the MS to reside in and hand over to the indoor coverage system smoothly. Moreover, the services are carried over inter-frequency carriers, and therefore, the indoor services do not need to occupy wireless resources of the outdoor macro cell system at all, and the spectrum utilization of the network is improved significantly.

Compared with a CDMA indoor coverage system which uses a repeater to provide the signal source, the embodiments of the present invention improve the network quality and the system capacity effectively.

The above descriptions are merely exemplary embodiments of the present invention, but not intended to limit the scope of the present invention. Any modifications, variations or replacements that can be easily derived by those skilled in the art shall fall within the scope of the present invention. Therefore, the scope of the present invention is subject to the appended claims.

What is claimed is:

1. A wireless communication method, wherein: a working frequency of a service carrier of an indoor coverage system is preset to be different from a working frequency of a service carrier of an outdoor macro cell system; a working frequency of a beacon carrier of the indoor coverage system is preset to be the same as the working frequency of the service carrier of the outdoor macro cell system; and a common channel is allocated on the beacon carrier of the indoor coverage system; the method comprises:
sending a system message at the working frequency of the beacon carrier of the indoor coverage system through the common channel, wherein the system message carries only information about the working frequency of the service carrier of the indoor coverage system, and the system message is used to instruct a Mobile Station (MS) to migrate to the working frequency of the service carrier of the indoor coverage system.

2. The method according to claim 1, wherein: a working frequency of a beacon carrier of the indoor coverage system is preset to be the same as the working frequency of the service carrier of the outdoor macro cell system comprises the following:
the working frequency of the beacon carrier of the indoor coverage system is set to be the working frequency of the service carrier of the outdoor macro cell system fixedly; or
the working frequency of the beacon carrier of the indoor coverage system is set to be using the working frequency of each service carrier of the outdoor macro cell system in turn by way of frequency hopping.

3. The method according to claim 2, wherein in frequency hopping way, before sending the system message, the method further comprises:
obtaining hopping configuration information, and determining the working frequency of the beacon carrier according to the hopping configuration information, wherein the hopping configuration information comprises working frequencies covered in a hopping range and a hopping mode between the working frequencies.

4. The method according to claim 1, further comprising:
setting a cell on the working frequency of the service carrier of the indoor coverage system to be an inter-frequency neighboring cell of a cell on the working frequency of the service carrier of the outdoor macro cell system; and
setting a cell on the working frequency of the beacon carrier of the indoor coverage system to be an intra-frequency neighboring cell of the cell on the working frequency of the service carrier of the outdoor macro cell system.

5. A Base Station (BS), comprising:
a service carrier unit, configured to preset a working frequency of a service carrier of an indoor coverage system to be different from a working frequency of a service carrier of an outdoor macro cell system; and
a beacon carrier unit, configured to preset a working frequency of a beacon carrier to be the same as the working frequency of the service carrier of the outdoor macro cell system; allocate a common channel on the beacon carrier of the indoor coverage system; and send a system message at the working frequency of the beacon carrier of the indoor coverage system through the common channel, wherein the system message carries only information about the working frequency of the service carrier of the indoor coverage system, and the system message is used to instruct a Mobile Station (MS) to migrate to the working frequency of the service carrier of the indoor coverage system.

6. The BS according to claim 5, wherein: a working frequency of a beacon carrier of the indoor coverage system is preset to be the same as the working frequency of the service carrier of the outdoor macro cell system comprises the following:
the working frequency of the beacon carrier of the indoor coverage system is set to be the working frequency of the service carrier of the outdoor macro cell system fixedly; or
the working frequency of the beacon carrier of the indoor coverage system is set to be using the working frequency of each service carrier of the outdoor macro cell system in turn by way of frequency hopping.

7. The BS according to claim 6, wherein when a frequency hopping mode is applied, the BS further comprises:
a hopping configuration information obtaining unit, configured to obtain hopping configuration information and determine the working frequency of the beacon carrier applied by the beacon carrier unit according to the hopping configuration information, wherein the hopping configuration information comprises working frequencies covered in a hopping range and a hopping mode between the working frequencies.

8. An indoor communication system, comprising:
a Base Station (BS), configured to: preset a working frequency of a service carrier of an indoor coverage system to be different from a working frequency of a service carrier of an outdoor macro cell system, preset a working frequency of a beacon carrier of the indoor coverage system to be the same as the working frequency of the service carrier of the outdoor macro cell system, allocate a common channel on the beacon carrier of the indoor coverage system, and send a system message at the working frequency of the beacon carrier of the indoor coverage system through the common channel, wherein the system message carries only information about the working frequency of the service carrier of the indoor coverage system, and the system message is used to instruct a Mobile Station (MS) to migrate to the working frequency of the service carrier of the indoor coverage system; and
an indoor distributed antenna, configured to receive and send information for the BS.

9. The system according to claim 8, wherein:
the BS is configured to preset the working frequency of the beacon carrier of the indoor coverage system to be the same as the working frequency of the service carrier of the outdoor macro cell system comprises the following:
the BS is configured to set the working frequency of the beacon carrier of the indoor coverage system to be the working frequency of the service carrier of the outdoor macro cell system fixedly; or
the BS is configured to use the working frequency of each service carrier of the outdoor macro cell system as the working frequency of the beacon carrier of the indoor coverage system in turn by way of frequency hopping.

10. A method for handover between wireless communication systems, comprising:
receiving, by a Mobile Station (MS), a system message sent by an indoor coverage system at a working frequency of a beacon carrier of the indoor coverage system when the MS moves from an outdoor macro cell system to the indoor coverage system, wherein the system message carries only information about a working frequency of a service carrier of the indoor coverage system, the working frequency of the service carrier of the indoor coverage system is different from a working frequency of a service carrier of the outdoor macro cell system, and the working frequency of the beacon carrier of the indoor coverage system is the same as the working frequency of the service carrier of the outdoor macro cell system; and
handing over, by the MS, to the working frequency of the service carrier of the indoor coverage system according to the information about the working frequency of the service carrier of the indoor coverage system in the system message.

11. The handover method according to claim 10, wherein before receiving the system message, the method further comprises:
handing over, by the MS, from the working frequency of the service carrier of the outdoor macro cell system that currently serves the MS to the working frequency of the beacon carrier of the current indoor coverage system.

12. The handover method according to claim 11, wherein the working frequency of the beacon carrier of the current indoor coverage system comprises:
a working frequency preset to be the same as the working frequency of the service carrier of the outdoor macro cell system; or
a working frequency preset in frequency hopping mode and corresponding to the beacon carrier of the indoor coverage system in a current hopping period.

13. A method for handover between wireless communication systems, comprising:
obtaining, by a Mobile Station (MS), preset inter-frequency neighboring cell information when moving from an indoor coverage system to an outdoor macro cell system, wherein the inter-frequency neighboring cell information indicates that a cell on a working frequency of a service carrier of the indoor coverage system is an inter-frequency neighboring cell of a cell on a working frequency of a service carrier of the outdoor macro cell system; and
handing over, by the MS, from the working frequency of the service carrier of the indoor coverage system to the working frequency of the service carrier of the outdoor macro cell system according to the inter-frequency neighboring cell information.
